(19) United States
(12) Patent Application Publication
(10) Pub. No.: US 2024/0187990 A1
(43) Pub. Date: Jun. 6, 2024

(54) EXTENDED DISCONTINUOUS RECEPTION DIFFERENTIATION FOR NEW RADIO (NR)

(71) Applicant: Telefonaktiebolaget LM Ericsson (publ), Stockholm (SE)

(72) Inventors: Qian CHEN, Mölndal (SE); Paul SCHLIWA-BERTLING, Ljungsbro (SE); Mohammed Yazid LYAZIDI, London (GB); Tuomas TIRRONEN, Helsinki (FI); Andreas HÖGLUND, Solna (SE)

(73) Assignee: Telefonaktiebolaget LM Ericsson (publ), Stockholm (SE)

(21) Appl. No.: 18/552,883

(22) PCT Filed: Mar. 31, 2022
(86) PCT No.: PCT/EP2022/058537

§ 371 Date: Sep. 27, 2023

Related U.S. Application Data
(60) Provisional application No. 63/168,560, filed on Mar. 31, 2021.

(51) Int. Cl. H04W 52/02; H04W 68/02; H04W 76/28

(52) U.S. Cl. CPC H04W 52/0235; H04W 68/02; H04W 76/28

(57) ABSTRACT

A method (900) performed by a first network function (302), the method comprising: transmitting (s902) toward a second network function a message including power saving information associated with new radio (NR) user equipments (UEs) and/or NR reduced capabilities (RedCap) UEs, wherein the power saving information is used for transmitting a paging message towards a user equipment (UE) from the second network function.

### TECHNICAL FIELD

This disclosure relates to extended Discontinuous Reception (eDRX) differentiation for New Radio (NR).

### BACKGROUND

FIG. 1 shows a simplified wireless system 100. As shown in FIG. 1, the wireless system 100 comprises a user equipment (UE) 102 and a base station (BS) 104 (NG-RAN node). The UE 102 is capable of transmitting and/or receiving data to/from the BS 104. The UE 102 may be a mobile phone, a laptop, a tablet, an Internet of Things (IoT) device, or any computing device that is capable of wirelessly connected to the BS 104.

To reduce power consumption of the UE 102 that is configured to wirelessly communicate with the BS 104, the UE 102 may operate in an extended Discontinuous Reception (eDRX) mode. FIG. 2 illustrates an eDRX mode 200. As shown in FIG. 2, in the eDRX mode 200, the UE 102 operates on an eDRX cycle 200. The eDRX cycle 200 may comprise a paging time window (PTW) 202 and a sleeping time interval 204. During the PTW 202, the UE 102 is configured to be capable of receiving paging message(s) from the BS 104. On the other hand, during the sleeping time interval 204, the UE 102 is configured to be not capable of receiving paging message(s) from the BS 104. The UE 102 is not capable of receiving paging message(s) from the BS 104 during the sleeping time interval 204 because the UE 102 sleeps during the sleeping time interval 204.

### SUMMARY

The eDRX mode may be used for 5G New Radio (NR) and 5G Reduced Capability (RedCap) NR. More specifically, the UEs capable of performing wireless communication using 5GNR and/or 5G RedCap NR may adapt the eDRX mode to reduce their power consumption. The UEs capable of performing wireless communication using 5G NR will be referred as NR UEs and the UEs capable of performing wireless communication using 5G Red Cap NR will be referred as Red Cap NR UEs.

In the 3rd Generation Partnership Project (3GPP) Technical Specification (TS) 38.875 v1.10, the eDRX mode for Red Cap NR UEs is specified. The disclosure of the TS is incorporated by reference in its entirety in this disclosure.

In the aforementioned TS, power saving of UEs operating on the eDRX in Radio Resource Control (RRC) inactive state (RRC_INACTIVE) and/or RRC idle state (RRC-IDLE) is discussed. The discussion includes analysis of UE power saving, possible upper and lower bounds for eDRX cycles, and possible mechanisms for eDRX for RedCap UEs disclosed in clauses 8.3.1-8.3.4. For example, the upper bound for DRX cycles and shorter eDRX values than 5.12 seconds, i.e., 2.56 seconds, have been studied and options are discussed in clause 8.3.3. In another example, solutions for PTW and eDRX cycle configuration and which node should configure the eDRX cycle for RRC_INACTIVE have been studied and solutions are captured in clause 8.3.4.

In the TS, based on the study of UE power saving on the eDRX, the followings are recommended from RAN2 perspective, where feasibility is to be confirmed with SA2 and/or CT1:
(i) The applicable parts of eDRX mechanisms for LTE, including use of H-SFN, PH and PTW, are expected to be re-used for RedCap UEs.
(ii) It is recommended that for eDRX cycles below and equal to 10.24 seconds, PTW and paging hyperframe (PH) are not used and that common design for handling eDRX cycle equal to 10.24 seconds in RRC_IDLE and RRC_INACTIVE is specified; and
(iii) It is recommended eDRX cycles in RRC_IDLE are extended up to 10485.76 seconds unless RAN4 indicates such eDRX value requires UE to perform Radio Resource Management (RRM) on serving cell outside PTW.
(iv) It is recommended eDRX cycles in RRC_INACTIVE are extended>10.24 seconds.

Certain challenges presently exist. When Access and Mobility and Management Function (AMF) allocates Registration Area (RA) which includes multiple Tracking Areas (TAs), the RA may include TA(s) covering NR cell(s) as well as TA(s) covering E-UTRA cells.

However, there may be a scenario where the eDRX operation for NR cell(s) and the eDRX operation for WB-E-UTRA may not work well together in the same RA. Furthermore, there may be a need to apply different eDRX parameters to normal NR cell(s) and Red Cap NR cell(s).

Accordingly, in one embodiment of this disclosure, separate eDRX parameters are provided for normal NR UE(s), Red Cap NR UE(s), UEs using the Wideband part of Evolved Universal Mobile Telecommunications System (WB-E-UTRA) for wireless communication, and UEs using the Narrowband part of E-UTRA (NB-E-UTRA).

More specifically, in some embodiments, different eDRX parameters for NR UEs and Red Cap NR UEs may be used at both N1 interface (using Non-Access Stratum (NAS) message(s)) and N2 interface (using New Generation Application Protocol (NGAP) messages). This allows supporting heterogeneous eDRX modes/operations in the same RA and the RAN Notification Area covering different cells, thereby still achieving significant power saving.

Also, in some embodiments, if the eDRX parameters for the normal NR UE(s) and the Red Cap NR UE(s) are the same, then common eDRX parameters may be shared between the normal NR UE(s) and the Red Cap NR UE(s).

Accordingly, in one aspect, there is provided a method performed by a user equipment (UE). The method comprises determining whether to transmit toward a network function first power saving information associated with new radio (NR) user equipments (UEs) and/or NR reduced capabilities (RedCap) UEs, based on the determination, including the first power saving information in a first message, and transmitting the first message toward the network function.

In another aspect, there is provided a method performed by a network function. The method comprises receiving a first message including first power saving information associated with new radio (NR) user equipments (UEs) and/or NR reduced capabilities (RedCap) UEs. The first message was transmitted by a user equipment (UE). The method further comprises determining whether the UE can use the first power saving information for power saving and based on the determination, transmitting toward the UE a second message comprising second power saving information associated with NR UEs and/or NR (RedCap) UEs.

In another aspect, there is provided a method performed by a first network function. The method comprises transmitting toward a second network function a message including power saving information associated with new radio (NR) user equipments (UEs) and/or NR reduced capabilities (RedCap) UEs. The power saving information is used for transmitting a paging message towards a user equipment (UE) from the second network function.

In another aspect, there is provided a method performed by a first network function. The method comprises receiving from a second network function a message including power saving information associated with new radio (NR) user equipments (UEs) and/or NR reduced capabilities (RedCap) UEs, and based on the power saving information, transmitting a UE paging message towards a user equipment (UE).

In another aspect, there is provided a computer program comprising instructions which when executed by processing circuitry of a UE, causes the UE to perform the above discussed method.

In another aspect, there is provided a computer program comprising instructions which when executed by processing circuitry of a network function, causes the network function to perform the above discussed methods.

In another aspect, there is provided a UE. The UE comprises processing circuitry; and a memory, the memory containing instructions executable by the processing circuitry, whereby the UE is configured to perform any one of the above discussed method.

In another aspect, there is provided a network function. The network function comprises processing circuitry and a memory. The memory contains instructions executable by the processing circuitry and the network function is configured to perform the above discussed methods.

In another aspect, there is provided a UE. The UE is configured to determine whether to transmit toward a network function first power saving information associated with new radio (NR) user equipments (UEs) and/or NR reduced capabilities (RedCap) UEs, based on the determination, include the first power saving information in a first message, and transmit the first message toward the network function.

In another aspect, there is provided a network function. The network function is configured to receive a first message including first power saving information associated with new radio (NR) user equipments (UEs) and/or NR reduced capabilities (RedCap) UEs. The first message was transmitted by a user equipment (UE). The network function is further configured to determine whether the UE can use the first power saving information for power saving, and based on the determination, transmit toward the UE a second message comprising second power saving information associated with NR UEs and/or NR (RedCap) UEs.

In another aspect, there is provided a first network function. The first network function is configured to transmit toward a second network function a message including power saving information associated with new radio (NR) user equipments (UEs) and/or NR reduced capabilities (RedCap) UEs. The power saving information is used for transmitting a paging message towards a user equipment (UE) from the second network function.

In another aspect, there is provided a first network function. The first network function is configured to receive from a second network function a message including power saving information associated with new radio (NR) user equipments (UEs) and/or NR reduced capabilities (RedCap) UEs, and based on the power saving information, transmit a UE paging message towards a user equipment (UE).

An advantage of the embodiments is that a UE and a network can support the Registration Area (RA) and/or the RAN-based Notification Area (RNA) that covers different cells (e.g., normal NR cell(s) and Red Cap NR cell(s), and WB-UTRA cell(s)) applying different eDRX parameters. More specifically, by allowing to provide different eDRX parameter values for NR, NR Red Cap, and WB-LTE, the RA (used by the AMF as the paging area when the AMF triggers the paging for UEs in CM-IDLE mode) and the RAN (used by the gNB as the paging area when the gNB triggers the paging for UEs in RRC Inactivate state) can be formulated with mixed TAls/cells of different radio types (WB-LTE, NR), except NB (Narrow Band). In those embodiments, no NAS mobility procedure is needed when switching between these different cells.

### BRIEF DESCRIPTION OF THE DRAWINGS

The accompanying drawings, which are incorporated herein and form part of the specification, illustrate various embodiments.

FIG. 1 shows a simplified wireless system.

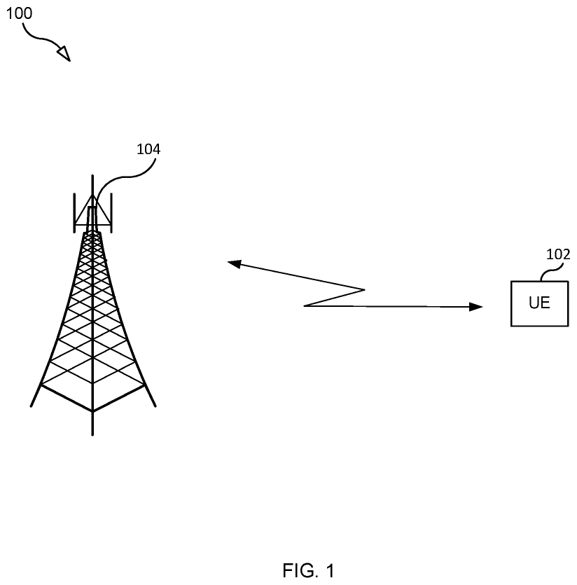

FIG. 2 illustrates an eDRX mode.

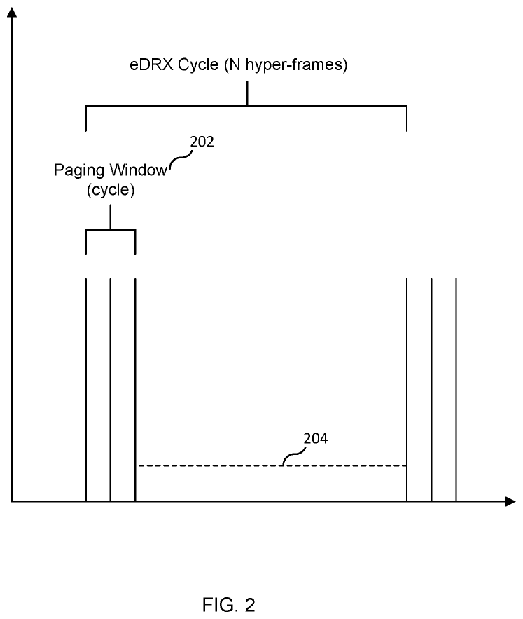

FIG. 3 is an expanded system architecture of the wireless system.

FIG. 4 shows UE registration process.

FIG. 5 shows a paging process according to an embodiment.

FIG. 6 shows a paging process according to an embodiment.

FIG. 7 shows a process showing according to an embodiment.

FIG. 8 shows a process showing according to an embodiment.

FIG. 9 shows a process showing according to an embodiment.

FIG. 10 shows a process showing according to an embodiment.

FIG. 11 shows a UE according to one embodiment.

FIG. 12 shows a network function according to one embodiment.

### DETAILED DESCRIPTION

eDRX Information/Parameters for NR and/or NR Red Cap in Registration Request/Accept Message

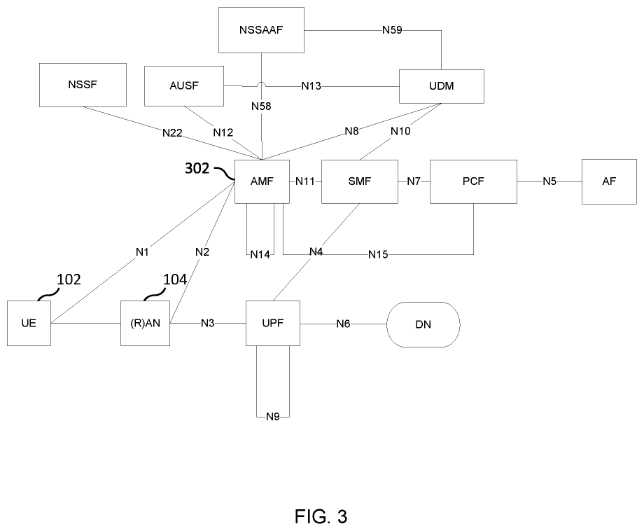

FIG. 3 shows an expanded system architecture 300 of the wireless system 100. The system architecture 300 may be a non-roaming 5G system architecture in reference point representation. The system architecture 300 may comprise the UE 102 and the BS (radio access network (RAN) node) 104.

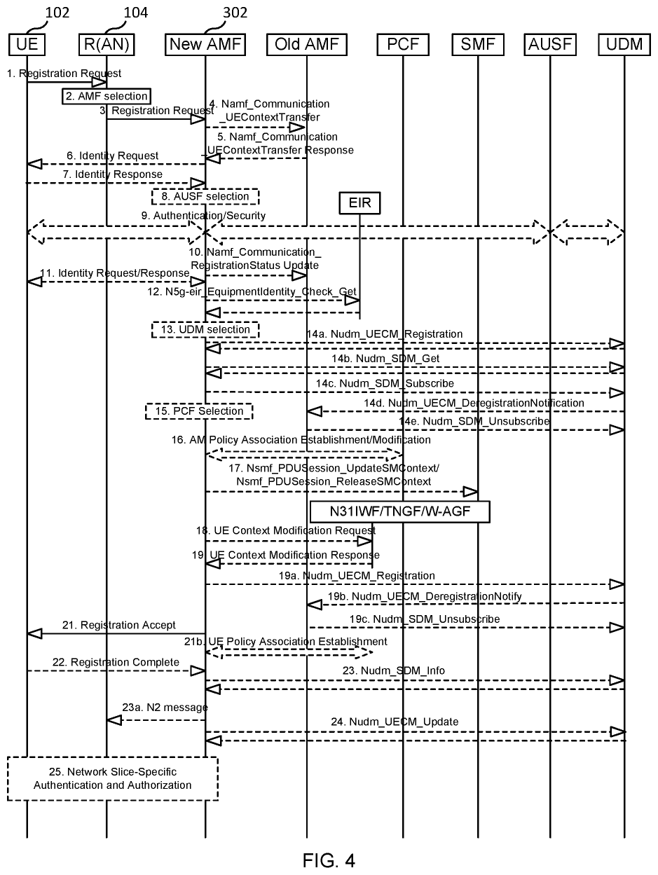

FIG. 4 shows a registration process 400 of the UE 102. The process 400 may begin with the UE 102 transmitting a Registration Request message 402 toward new AMF 302 via the BS 104. The Registration Request message 402 is for registering the UE 102 to the new AMF 302. The paragraph below lists various information elements (IEs) that can be included in the Registration Request message 402.
UE to (R)AN: AN message (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [extended idle mode DRX parameters for NR], [extended idle mode DRX parameters for RedCap], [LADN DNN(s) or Indicator Of Requesting LADN Information], [NAS message container], [Support for restriction of use of Enhanced Coverage], [Preferred Network Behavior], [UE paging probability information], [UE Policy Container (the list of PSIs, indication of UE support for ANDSP and the operating system identifier)] and [UE Radio Capability ID], PEI)).

Table 1 shows the content of the Registration Request message 402 according to one embodiment. As shown in the Table 1, the Registration Request message 402 may comprise one or more requested eDRX parameters for NR and one or more requested eDRX parameters for Red Cap.

TABLE 1

| IEI | Information Element | Type/Reference | Presence | Format | Length |
|---|---|---|---|---|---|
| | Extended protocol discriminator | Extended Protocol discriminator | M | V | 1 |
| | | 9.2 | | | |
| | Security header type | Security header type | M | V | ½ |
| | | 9.3 | | | |
| | Spare half octet | Spare half octet | M | V | ½ |
| | | 9.5 | | | |
| | Registration request message | Message type | M | V | 1 |
| | identity | 9.7 | | | |
| | 5GS registration type | 5GS registration type | M | V | ½ |
| | | 9.11.3.7 | | | |
| | ngKSI | NAS key set identifier | M | V | ½ |
| | | 9.11.3.32 | | | |
| | 5GS mobile identity | 5GS mobile identity | M | LV-E | 6-n |
| | | 9.11.3.4 | | | |
| C- | Non-current native NAS key set | NAS key set identifier | O | TV | 1 |
| | identifier | 9.11.3.32 | | | |
| 10 | 5GMM capability | 5GMM capability | O | TLV | 3-15 |
| | | 9.11.3.1 | | | |
| 2E | UE security capability | UE security capability | O | TLV | 4-10 |
| | | 9.11.3.54 | | | |
| 2F | Requested NSSAI | NSSAI | O | TLV | 4-74 |
| | | 9.11.3.37 | | | |
| 52 | Last visited registered TAI | 5GS tracking area identity | O | TV | 7 |
| | | 9.11.3.8 | | | |
| 17 | S1 UE network capability | S1 UE network capability | O | TLV | 4-15 |
| | | 9.11.3.48 | | | |
| 40 | Uplink data status | Uplink data status | O | TLV | 4-34 |
| | | 9.11.3.57 | | | |
| 50 | PDU session status | PDU session status | O | TLV | 4-34 |
| | | 9.11.3.44 | | | |
| B- | MICO indication | MICO indication | O | TV | 1 |
| | | 9.11.3.31 | | | |
| 2B | UE status | UE status | O | TLV | 3 |
| | | 9.11.3.56 | | | |
| 77 | Additional GUTI | 5GS mobile identity | O | TLV-E | 14 |
| | | 9.11.3.4 | | | |
| 25 | Allowed PDU session status | Allowed PDU session status | O | TLV | 4-34 |
| | | 9.11.3.13 | | | |
| 18 | UE's usage setting | UE's usage setting | O | TLV | 3 |
| | | 9.11.3.55 | | | |
| 51 | Requested DRX parameters | 5GS DRX parameters | O | TLV | 3 |
| | | 9.11.3.2A | | | |
| 70 | EPS NAS message container | EPS NAS message container | O | TLV-E | 4-n |
| | | 9.11.3.24 | | | |
| 74 | LADN indication | LADN indication | O | TLV-E | 3-811 |
| | | 9.11.3.29 | | | |
| 8- | Payload container type | Payload container type | O | TV | 1 |
| | | 9.11.3.40 | | | |
| 7B | Payload container | Payload container | O | TLV-E | 4-65538 |
| | | 9.11.3.39 | | | |
| 9- | Network slicing indication | Network slicing indication | O | TV | 1 |
| | | 9.11.3.36 | | | |
| 53 | 5GS update type | 5GS update type | O | TLV | 3 |
| | | 9.11.3.9A | | | |
| 41 | Mobile station classmark 2 | Mobile station classmark 2 | O | TLV | 5 |
| | | 9.11.3.31C | | | |
| 42 | Supported codecs | Supported codec list | O | TLV | 5-n |
| | | 9.11.3.51A | | | |
| 71 | NAS message container | NAS message container | O | TLV-E | 4-n |
| | | 9.11.3.33 | | | |
| 60 | EPS bearer context status | EPS bearer context status | O | TLV | 4 |
| | | 9.11.3.23A | | | |
| 6E | Requested extended DRX | Extended DRX parameters | O | TLV | 3 |
| | parameters | 9.11.3.26A | | | |
| 6A | T3324 value | GPRS timer 3 | O | TLV | 3 |
| | | 9.11.2.5 | | | |
| 67 | UE radio capability ID | UE radio capability ID | O | TLV | 3-n |
| | | 9.11.3.68 | | | |
| 35 | Requested mapped NSSAI | Mapped NSSAI | O | TLV | 3-42 |
| | | 9.11.3.31B | | | |
| 48 | Additional information requested | Additional information requested | O | TLV | 3 |
| | | 9.11.3.12A | | | |
| 1A | Requested WUS assistance | WUS assistance information | O | TLV | 3-n |
| | information | 9.11.3.71 | | | |
| A- | N5GC indication | N5GC indication | O | T | 1 |
| | | 9.11.3.72 | | | |
| 30 | Requested NB-N1 mode DRX | NB-N1 mode DRX parameters | O | TLV | 3 |
| | parameters | 9.11.3.73 | | | |
| X | Requested extended DRX | | O | TLV | 3 |
| | parameters for NR | | | | |
| X | Requested extended DRX | | O | TLV | 3 |
| | parameters for RedCap | | | | |

Each of the eDRX parameters for NR and Red Cap NR may comprise PTW and eDRX cycle. One eDRX cycle may comprise a PTW and a sleeping time interval. During the PTW, the UE 102 is configured to be capable of receiving paging signals (messages) from the BS 104. On the other hand, during the sleeping time interval, the UE 102 is configured to be not capable of receiving paging signals from the BS 104. The UE 102 is not capable of receiving paging signals from the BS 104 during the sleeping time interval because the UE 102 sleeps during the sleeping time interval.

Because, in this embodiment, the eDRX parameters for normal NR and Red Cap NR are separately provided in addition to existing eDRX parameter(s), the existing eDRX parameter(s)—“Requested extended eDRX parameter”—may be set to be used for WB-E-UTRA and NB-IoT.

In one embodiment, the eDRX parameters may be selectively included in the Registration Request message 402. For example, the UE 102 may determine a need to reduce power consumption of the UE 102 and as a result of the UE 102 determining that there is a need to reduce power consumption of the UE 102, the UE 102 may selectively include within the Registration Request message 402 the eDRX parameters. There may be different ways of determining the need to reduce power consumption of the UE 102. For example, the UE 102 may be a battery-powered device and may compare the remaining battery level of the UE 102 to a threshold level. Based on the determination that the remaining battery level of the UE 102 is less than and/or equal to the threshold level, the UE 102 may determine that the UE needs to reduce the power consumption of the UE 102.

In some embodiments, if the eDRX parameters or normal NR and the eDRX parameters for Red Cap NR are the same, the UE may just include the eDRX parameters for NR.

Referring back to FIG. 4, after the new AMF 302 determines to register the UE 102, the new AMF 302 may transmit toward the UE 102 a Registration Accept message 404. The Registration Accept message 404 indicates to the UE 102 that the UE 102 has been registered. The paragraph below lists various information elements (IEs) that can be included in the Registration Accept message 404.
New AMF to UE: Registration Accept (5G-GUTI, Registration Area, [Mobility restrictions], [PDU Session status], [Allowed NSSAI], [Mapping Of Allowed NSSAI], [Configured NSSAI for the Serving PLMN], [Mapping Of Configured NSSAI], [rejected S-NSSAIs], [Pending NSSAI], [Mapping Of Pending NSSAI], [Periodic Registration Update timer], [Active Time], [Strictly Periodic Registration Timer Indication], [LADN Information], [accepted MICO mode], [IMS Voice over PS session supported Indication], [Emergency Service Support indicator], [Accepted DRX parameters for E-UTRA and NR], [Accepted DRX parameters for NB-IoT], [extended idle mode DRX parameters], [extended idle mode DRX parameters for NR], [extended idle mode DRX parameters for RedCap][Paging Time Window], [Network support of Interworking without N26], [Access Stratum Connection Establishment NSSAI Inclusion Mode], [Network Slicing Subscription Change Indication], [Operator-defined access category definitions], [List of equivalent PLMNs], [Enhanced Coverage Restricted information], [Supported Network Behaviour], [Service Gap Time], [PLMN-assigned UE Radio Capability ID], [PLMN-assigned UE Radio Capability ID deletion], [WUS Assistance Information], [Truncated 5G-S-TMSI Configuration]).

In some embodiments, if the eDRX parameters for normal NR and the eDRX parameters for Red Cap NR are the same, the UE may just include the eDRX parameters for NR.

Table 2 shows the content of the Registration Accept message 404 according to one embodiment. As shown in the Table 2 below, the Registration Accept message 404 may comprise one or more negotiated eDRX parameters for NR and one or more requested eDRX parameters for Red Cap.

TABLE 2

| IEI | Information Element | Type/Reference | Presence | Format | Length |
|---|---|---|---|---|---|
| | Extended protocol discriminator | Extended protocol discriminator | M | V | 1 |
| | | 9.2 | | | |
| | Security header type | Security header type | M | V | ½ |
| | | 9.3 | | | |
| | Spare half octet | Spare half octet | M | V | ½ |
| | | 9.5 | | | |
| | Registration accept message | Message type | M | V | 1 |
| | identity | 9.7 | | | |
| | 5GS registration result | 5GS registration result | M | LV | 2 |
| | | 9.11.3.6 | | | |
| 77 | 5G-GUTI | 5GS mobile identity | O | TLV-E | 14 |
| | | 9.11.3.4 | | | |
| 4A | Equivalent PLMNs | PLMN list | O | TLV | 5-47 |
| | | 9.11.3.45 | | | |
| 54 | TAI list | 5GS tracking area identity list | O | TLV | 9-114 |
| | | 9.11.3.9 | | | |
| 15 | Allowed NSSAI | NSSAI | O | TLV | 4-74 |
| | | 9.11.3.37 | | | |
| 11 | Rejected NSSAI | Rejected NSSAI | O | TLV | 4-42 |
| | | 9.11.3.46 | | | |
| 31 | Configured NSSAI | NSSAI | O | TLV | 4-146 |
| | | 9.11.3.37 | | | |
| 21 | 5GS network feature support | 5GS network feature support | O | TLV | 3-5 |
| | | 9.11.3.5 | | | |
| 50 | PDU session status | PDU session status | O | TLV | 4-34 |
| | | 9.11.3.44 | | | |
| 26 | PDU session reactivation result | PDU session reactivation result | O | TLV | 4-34 |
| | | 9.11.3.42 | | | |
| 72 | PDU session reactivation result | PDU session reactivation result error | O | TLV-E | 5-515 |
| | error cause | cause | | | |
| | | 9.11.3.43 | | | |
| 79 | LADN information | LADN information | O | TLV-E | 12-1715 |
| | | 9.11.3.30 | | | |
| B- | MICO indication | MICO indication | O | TV | 1 |
| | | 9.11.3.31 | | | |
| 9- | Network slicing indication | Network slicing indication | O | TV | 1 |
| | | 9.11.3.36 | | | |
| 27 | Service area list | Service area list | O | TLV | 6-114 |
| | | 9.11.3.49 | | | |
| 5E | T3512 value | GPRS timer 3 | O | TLV | 3 |
| | | 9.11.2.5 | | | |
| 5D | Non-3GPP de-registration timer | GPRS timer 2 | O | TLV | 3 |
| | value | 9.11.2.4 | | | |
| 16 | T3502 value | GPRS timer 2 | O | TLV | 3 |
| | | 9.11.2.4 | | | |
| 34 | Emergency number list | Emergency number list | O | TLV | 5-50 |
| | | 9.11.3.23 | | | |
| 7A | Extended emergency number list | Extended emergency number list | O | TLV-E | 7-65538 |
| | | 9.11.3.26 | | | |
| 73 | SOR transparent container | SOR transparent container | O | TLV-E | 20-n |
| | | 9.11.3.51 | | | |
| 78 | EAP message | EAP message | O | TLV-E | 7-1503 |
| | | 9.11.2.2 | | | |
| A- | NSSAI inclusion mode | NSSAI inclusion mode | O | TV | 1 |
| | | 9.11.3.37A | | | |
| 76 | Operator-defined access category | Operator-defined access category | O | TLV-E | 3-n |
| | definitions | definitions | | | |
| | | 9.11.3.38 | | | |
| 51 | Negotiated DRX parameters | 5GS DRX parameters | O | TLV | 3 |
| | | 9.11.3.2A | | | |
| D- | Non-3GPP NW policies | Non-3GPP NW provided policies | O | TV | 1 |
| | | 9.11.3.36A | | | |
| 60 | EPS bearer context status | EPS bearer context status | O | TLV | 4 |
| | | 9.11.3.23A | | | |
| 6E | Negotiated extended DRX | Extended DRX parameters | O | TLV | 3 |
| | parameters | 9.11.3.26A | | | |
| 6C | T3447 value | GPRS timer 3 | O | TLV | 3 |
| | | 9.11.2.5 | | | |
| 6B | T3448 value | GPRS timer 2 | O | TLV | 3 |
| | | 9.11.2.4 | | | |
| 6A | T3324 value | GPRS timer 3 | O | TLV | 3 |
| | | 9.11.2.5 | | | |
| 67 | UE radio capability ID | UE radio capability ID | O | TLV | 3-n |
| | | 9.11.3.68 | | | |
| E- | UE radio capability ID deletion | UE radio capability ID deletion | O | TV | 1 |
| | indication | indication | | | |
| | | 9.11.3.69 | | | |
| 39 | Pending NSSAI | NSSAI | O | TLV | 4-146 |
| | | 9.11.3.37 | | | |
| 74 | Ciphering key data | Ciphering key data | O | TLV-E | 34-n |
| | | 9.11.3.18C | | | |
| 75 | CAG information list | CAG information list | O | TLV-E | 3-n |
| | | 9.11.3.18A | | | |
| 1B | Truncated 5G-S-TMSI | Truncated 5G-S-TMSI configuration | O | TLV | 3 |
| | configuration | 9.11.3.70 | | | |
| 1C | Negotiated WUS assistance | WUS assistance information | O | TLV | 3-n |
| | information | 9.11.3.71 | | | |
| 29 | Negotiated NB-N1 mode DRX | NB-N1 mode DRX parameters | O | TLV | 3 |
| | parameters | 9.11.3.73 | | | |
| X | Negotiated extended DRX | X | O | TLV | 3 |
| | parameters for NR | | | | |
| X | Negotiated extended DRX | X | O | TLV | 3 |
| | parameters for RedCap | | | | |

The negotiated eDRX parameters may be stored in UE context that is stored in the BS 104. Using these different eDRX parameters for different cells (e.g., gNB, WB-E-UTRA), the AMF can formulate RA including TAs that contain cells for NB, WB-E-UTRA, NR with Red Cap Support.

Each of the eDRX parameters for NR and Red Cap NR may comprise PTW and eDRX cycle. One eDRX cycle may comprise a PTW and a sleeping time interval. During the PTW, the UE 102 is configured to be capable of receiving paging signals from the BS 104. On the other hand, during the sleeping time interval, the UE 102 is configured to be not capable of receiving paging signals from the BS 104. The UE 102 is not capable of receiving paging signals from the BS 104 during the sleeping time interval because the UE 102 sleeps during the sleeping time interval.

Because, in this embodiment, the eDRX parameters for NR and Red Cap NR for normal NR and Red Cap NR are separately provided in addition to existing eDRX parameter(s), the existing eDRX parameter(s)—“Requested extended eDRX parameter”—may be set to be used for WB-E-UTRA and NB-IoT.

eDRX Information for NR and/or NR Red Cap in NGAP Message(s)

In one embodiment, the AMF 302 may transmit to the BS 104 (e.g, gNB serving NG-RAN) message(s) including information regarding eDRX mode (“Paging eDRX Information”) for NR UEs and/or Red Cap NR UEs via NG Application Protocol (NGAP) especially whenever the context of the UE 102 (UE context) needs to be established or modified in the NG-RAN. Similarly, the AMF 302 may transmit to NG-eNB message(s) including information regarding eDRX mode for WB-E-UTRAN. A

The NGAP messages including the Paging eDRX information for NR UEs and/or Red Cap NR UEs may be a NGAP paging message, an Initial Context Setup Request message, a Handover Request message, a Path Switch Request Acknowledge message, and UE context modification message. Any of the NGAP messages may include Core Network (CN) Assistance Information for RRC Inactive, which includes the Paging eDRX information for NR and for Red Cap NR.

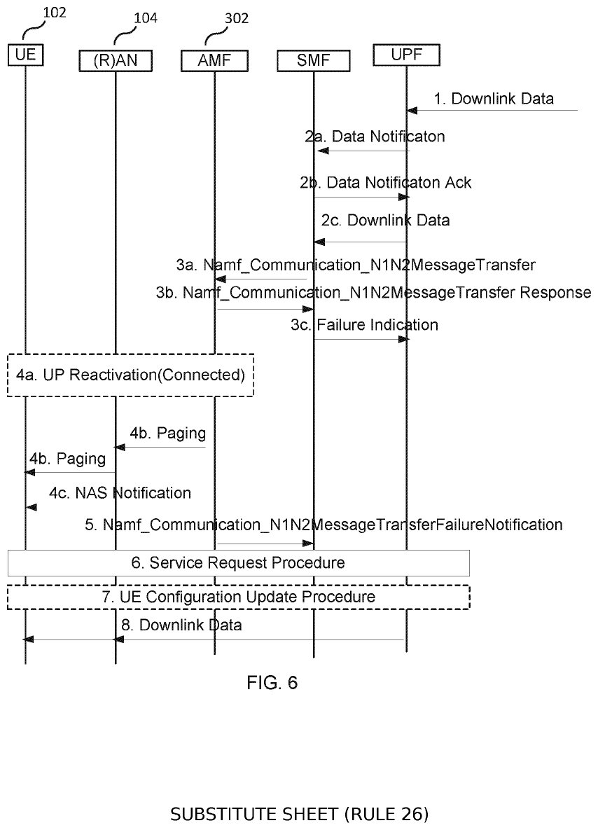

In case the NGAP message is a NGAP paging message, as shown in FIG. 6, the AMF 302 may formulate the NGAP paging message 602 that includes the Paging eDRX information for NR UEs and/or Red Cap NR UEs, and transmit the message 602 toward the BS 104.

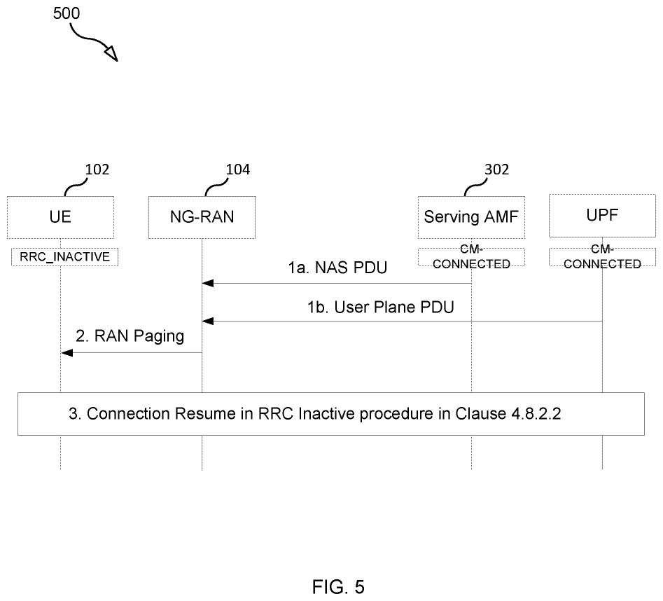

In case the NGAP message is one of an Initial Context Setup Request message, a Handover Request message, a Path Switch Request Acknowledge message, and UE context modification message, the AMF 302 may transmit the Paging eDRX information to the BS 104, as illustrated in FIG. 5. Using the received paging eDRX information, the BS 104 may formulate and transmit paging message(s) to the UE 102 in the RRC Inactive state (which is in Tracking Area(s)).

Table 3 provided below shows a list of information elements that may be included in the Initial Context Setup Request message (as specified in TS 38.413) transmitted from the AMF 302 to the BS 104 according to the above embodiment. The Initial Context Setup Request message is for requesting to set up a UE context.

TABLE 3

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF UE NGAP ID | M | | 9.3.3.1 | | YES | reject |
| RAN UE NGAP ID | M | | 9.3.3.2 | | YES | reject |
| Old AMF | O | | AMF Name | | YES | reject |
| | | | 9.3.3.21 | | | |
| UE Aggregate Maximum | C- | | 9.3.1.58 | | YES | reject |
| Bit Rate | ifPDUsessionResourceSetup | | | | | |
| Core Network | O | | 9.3.1.15 | | YES | ignore |
| Assistance Information | | | | | | |
| for RRC INACTIVE | | | | | | |
| GUAMI | M | | 9.3.3.3 | | YES | reject |
| PDU Session Resource | | 0 . . . 1 | | | YES | reject |
| Setup Request List | | | | | | |
| >PDU Session | | 1 . . . | | | — | |
| Resource Setup | | <maxnoofPDUSessions> | | | | |
| Request Item | | | | | | |
| >>PDU Session ID | M | | 9.3.1.50 | | — | |
| >>PDU Session NAS- | O | | NAS-PDU | | — | |
| PDU | | | 9.3.3.4 | | | |
| >>S-NSSAI | M | | 9.3.1.24 | | — | |
| >>PDU Session | M | | OCTET STRING | Containing the | — | |
| Resource Setup | | | | PDU Session | | |
| Request Transfer | | | | Resource Setup | | |
| | | | | Request Transfer | | |
| | | | | IE specified in | | |
| | | | | subclause 9.3.4.1. | | |
| Allowed NSSAI | M | | 9.3.1.31 | Indicates the S- | YES | reject |
| | | | | NSSAIs permitted | | |
| | | | | by the network | | |
| UE Security Capabilities | M | | 9.3.1.86 | | YES | reject |
| Security Key | M | | 9.3.1.87 | | YES | reject |
| Trace Activation | O | | 9.3.1.14 | | YES | ignore |
| Mobility Restriction List | O | | 9.3.1.85 | | YES | ignore |
| UE Radio Capability | O | | 9.3.1.74 | | YES | ignore |
| Index to RAT/Frequency | O | | 9.3.1.61 | | YES | ignore |
| Selection Priority | | | | | | |
| Masked IMEISV | O | | 9.3.1.54 | | YES | ignore |
| NAS-PDU | O | | 9.3.3.4 | | YES | ignore |
| Emergency Fallback | O | | 9.3.1.26 | | YES | reject |
| Indicator | | | | | | |
| RRC Inactive Transition | O | | 9.3.1.91 | | YES | ignore |
| Report Request | | | | | | |
| UE Radio Capability for | O | | 9.3.1.68 | | YES | ignore |
| Paging | | | | | | |
| Redirection for Voice | O | | 9.3.1.116 | | YES | ignore |
| EPS Fallback | | | | | | |
| Location Reporting | O | | 9.3.1.65 | | YES | ignore |
| Request Type | | | | | | |
| CN Assisted RAN | O | | 9.3.1.119 | | YES | ignore |
| Parameters Tuning | | | | | | |
| SRVCC Operation | O | | 9.3.1.128 | | YES | ignore |
| Possible | | | | | | |
| IAB Authorized | O | | 9.3.1.129 | | YES | ignore |
| Enhanced Coverage | O | | 9.3.1.140 | | YES | ignore |
| Restriction | | | | | | |
| Extended Connected | O | | 9.3.3.31 | | YES | ignore |
| Time | | | | | | |
| UE Differentiation | O | | 9.3.1.144 | | YES | ignore |
| Information | | | | | | |
| NR V2X Services | O | | 9.3.1.146 | | YES | ignore |
| Authorized | | | | | | |
| LTE V2X Services | O | | 9.3.1.147 | | YES | ignore |
| Authorized | | | | | | |
| NR UE Sidelink | O | | 9.3.1.148 | This IE applies | YES | ignore |
| Aggregate Maximum Bit | | | | only if the UE is | | |
| Rate | | | | authorized for NR | | |
| | | | | V2X services. | | |
| LTE UE Sidelink | 0O | | 9.3.1.149 | This IE applies | YES | ignore |
| Aggregate Maximum Bit | | | | only if the UE is | | |
| Rate | | | | authorized for LTE | | |
| | | | | V2X services. | | |
| PC5 QoS Parameters | O | | 9.3.1.150 | This IE applies | YES | ignore |
| | | | | only if the UE is | | |
| | | | | authorized for NR | | |
| | | | | V2X services. | | |
| CE-mode-B Restricted | O | | 9.3.1.155 | | YES | ignore |
| UE User Plane CIoT | O | | 9.3.1.160 | | YES | ignore |
| Support Indicator | | | | | | |
| RG Level Wireline | O | | OCTET STRING | Specified in TS | YES | ignore |
| Access Characteristics | | | | 23.316 [34]. | | |
| | | | | Indicates the | | |
| | | | | wireline access | | |
| | | | | technology specific | | |
| | | | | QoS information | | |
| | | | | corresponding to a | | |
| | | | | specific wireline | | |
| | | | | access | | |
| | | | | subscription. | | |
| Management Based | O | | MDT PLMN List | | YES | ignore |
| MDT PLMN List | | | 9.3.1.168 | | | |
| UE Radio Capability ID | O | | 9.3.1.142 | | YES | reject |

Table 4 provided below shows a list of information elements that may be included in the Core Network (CN) Assistance Information for RRC Inactive. The Core Network (CN) Assistance Information for RRC Inactive is the information element providing assistance information for RRC_INACTIVE configuration.

TABLE 4

| | | | | |
|---|---|---|---|---|
| | | | IE type and | Semantics |
| IE/Group Name | Presence | Range | reference | description |

| | | | |
|---|---|---|---|
| UE Identity Index Value | M | | 9.3.3.23 |
| UE Specific DRX | O | | Paging DRX |
| | | | 9.3.1.90 |
| Periodic Registration | M | | 9.3.3.24 |
| Update Timer | | | |
| MICO Mode Indication | O | | 9.3.1.23 |
| TAI List for RRC Inactive | | 1 | |
| >TAI List for RRC Inactive | | 1 . . . | |
| Item | | <maxnoofTAIforInactive> | |
| >>TAI | M | | 9.3.3.11 |
| Expected UE Behaviour | O | | 9.3.1.93 |
| Paging eDRX Information | O | | 9.3.1.154 |
| Paging eDRX information | O | | 9.3.1.xx |
| for NR | | | |
| Paging eDRX Information | O | | 9.3.1.yy |
| for RedCap | | | |

The Paging eDRX information for NR is an information element indicating paging eDRX parameters for NR UEs.

Table 5 provided below shows a list of information elements that may be included in the Paging eDRX information for NR (as specified in TS 38.304).

TABLE 5

| | | | | |
|---|---|---|---|---|
| | | | IE type and | |
| IE/Group Name | Presence | Range | reference | Semantics description |

| | | | |
|---|---|---|---|
| Paging eDRX | M | ENUMERATED | TeDRX defined in TS 38.304. |
| Cycle for Idle | | (hfhalf, hf1, hf2, hf4, | Unit: [number of hyperframes]. |
| | | hf6, hf8, hf10, hf12, | |
| | | hf14, hf16, hf32, | |
| | | hf64, hf128, hf256, . . . , | |
| | | hf512, hf1024) | |
| Paging eDRX Cycle | M | ENUMERATED | TeDRX defined in TS 38.304. |
| for Inactive | | (hfhalf, hf1, hf2, hf4, | Unit: [number of hyperframes]. |
| | | hf6, hf8, hf10, hf12, | |
| | | hf14, hf16, hf32, | |
| | | hf64, hf128, hf256, . . . , | |
| | | hf512, hf1024, TBD) | |
| Paging Time | O | ENUMERATED | Unit: [1.28 second]. |
| Window | | (s1, s2, s3, s4, s5, | |
| | | s6, s7, s8, s9, s10, | |
| | | s11, s12, s13, s14, | |
| | | s15, s16, . . .) | |

The Paging eDRX information for Red Cap is an information element indicating paging eDRX parameters for NR Red Cap UEs.

Table 6 provided below shows a list of information elements that may be included in the Paging eDRX information for NR Red Cap (as specified in TS 38.304).

TABLE 6

| | | | | |
|---|---|---|---|---|
| | | | IE type and | |
| IE/Group Name | Presence | Range | reference | Semantics description |

| | | | |
|---|---|---|---|
| Paging eDRX Cycle | M | ENUMERATED | TeDRX defined in TS 38.304. |
| for Idle | | (hfhalf, hf1, hf2, hf4, | Unit: [number of hyperframes]. |
| | | hf6, hf8, hf10, hf12, | |
| | | hf14, hf16, hf32, | |
| | | hf64, hf128, hf256, . . . , | |
| | | hf512, hf1024) | |
| Paging eDRX Cycle | M | ENUMERATED | TeDRX defined in TS 38.304. |
| for Inactive | | (hfhalf, hf1, hf2, hf4, | Unit: [number of hyperframes]. |
| | | hf6, hf8, hf10, hf12, | |
| | | hf14, hf16, hf32, | |
| | | hf64, hf128, hf256, . . . , | |
| | | hf512, hf1024, | |
| | | maximum TBD) | |
| Paging Time Window | O | ENUMERATED | Unit: [1.28 second]. |
| | | (s1, s2, s3, s4, s5, | |
| | | s6, s7, s8, s9, s10, | |
| | | s11, s12, s13, s14, | |
| | | s15, s16, . . .) | |

The BS 104 may use the eDRX information provided by the AMF 302 when the BS 104 triggers the RAN paging for UEs in RRC inactive state.

FIG. 6 shows a message flow diagram. As shown in the FIG. 6, the AMF 302 transmits to the BS 104 a message 4b that includes Core Network Assistance Information for RRC INACTIVE. As discussed above, the Core Network Assistance Information for RRC INACTIVE may include Paging eDRX information for NR and the Paging eDRX information for Red Cap NR. Using the received Paging eDRX information for NR and the Paging eDRX information for Red Cap NR, the BS 104 may transmit a paging message 4b to the UE 102.

Table 7 provided below shows a list of information elements that may be included in the NGAP message(s) (as specified in TS 38.413) transmitted from the AMF 302 to the BS 104 according to the above embodiment.

TABLE 7

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| UE Paging Identity | M | | 9.3.3.18 | | YES | ignore |
| Paging DRX | O | | 9.3.1.90 | | YES | ignore |
| TAI List for Paging | | 1 | | | YES | ignore |
| >TAI List for Paging | | 1 . . . | | | — | |
| Item | | <maxnoofTAIforPaging> | | | | |
| >>TAI | M | | 9.3.3.11 | | — | |
| Paging Priority | O | | 9.3.1.78 | | YES | ignore |
| UE Radio Capability for | O | | 9.3.1.68 | | YES | ignore |
| Paging | | | | | | |
| Paging Origin | O | | 9.3.3.22 | | YES | ignore |
| Assistance Data for | O | | 9.3.1.69 | | YES | ignore |
| Paging | | | | | | |
| NB-IoT Paging eDRX | O | | 9.3.1.138 | | YES | ignore |
| Information | | | | | | |
| NB-IoT Paging DRX | O | | 9.3.1.139 | If this IE is present, | YES | ignore |
| | | | | the Paging DRX IE | | |
| | | | | is ignored. | | |
| Enhanced Coverage | O | | 9.3.1.140 | | YES | ignore |
| Restriction | | | | | | |
| WUS Assistance | O | | 9.3.1.143 | | YES | ignore |
| Information | | | | | | |
| Paging eDRX Information | O | | 9.3.1.154 | | YES | ignore |
| CE-mode-B Restricted | O | | 9.3.1.155 | | YES | ignore |
| Paging eDRX | O | | 9.3.1.xx | Only present if | | |
| Information for NR | | | | NG-RAN node is | | |
| | | | | gNB | | |
| Paging eDRX | O | | 9.3.1.yy | Only present if | | |
| Information for RedCap | | | | NG-RAN node is | | |
| | | | | gNB | | |

eDRX Signaling for NR and/or NR Red Cap in Split gNB

The functions of the BS 104 (e.g., gNB) may be divided between a central unit (CU) and distributed units (DUs). The CU is a logical node performing certain gNB functions like mobility control, transfer of user data, etc. The CU controls the operation of the DUs over front-haul (Fs) interface. Each of the DUs is a logical node performing a subset of gNB functions and its operation is controlled by the CU.

In one embodiment, in gNB CU-DU split, information regarding eDRX mode (“Paging eDRX Information”) for NR UEs and/or Red Cap NR UEs is transmitted from the CU to the DUs. For example, the CU may formulate paging message(s) that includes the Paging eDRX Information, and transmit the paging message(s) toward the DUs via F1AP interface. The Paging eDRX information may include information related to eDRX mode (e.g., eDRX cycle).

After receiving the paging message(s) that includes the Paging eDRX information, each of the DUs can use the Paging eDRX Information to transmit paging message(s) to UEs in RRC inactive state. For example, each of the DUs may use the eDRX cycle indicated in the Paging eDRX Information as a cycle of transmitting paging message(s) to UEs.

Table 8 provided below shows a list of information elements that may be included in the paging message(s) (as specified in TS 38.473) transmitted from the CU to the DUs.

TABLE 8

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| UE Identity Index value | M | | 9.3.1.39 | | YES | reject |
| CHOICE Paging Identity | M | | | | YES | reject |
| >RAN UE Paging identity | M | | 9.3.1.43 | | — | |
| >CN UE paging identity | M | | 9.3.1.44 | | — | |
| Paging DRX | O | | 9.3.1.40 | It is defined | YES | ignore |
| | | | | as the | | |
| | | | | minimum | | |
| | | | | between the | | |
| | | | | RAN UE | | |
| | | | | Paging DRX | | |
| | | | | and CN UE | | |
| | | | | Paging DRX | | |
| Paging Priority | O | | 9.3.1.41 | | YES | ignore |
| Paging Cell List | | 1 | | | YES | ignore |
| >Paging Cell Item IEs | | 1 . . . | | | EACH | ignore |
| | | <maxnoofPagingCells> | | | | |
| >>NR CGI | M | | 9.3.1.12 | | — | |
| Paging Origin | O | | 9.3.1.79 | | YES | ignore |
| Paging eDRX Information for NR | O | | 9.3.1.xx | | | |
| Paging eDRX Information for | O | | 9.3.1.yy | | | |
| RedCap | | | | | | |

eDRX Signaling for NR and/or NR Red Cap Between gNB

In one embodiment, information regarding eDRX mode (“Paging eDRX Information”) for NR UEs and/or Red Cap NR UEs may be transmitted from one network function (e.g., gNB) to another network function (e.g., gNB) in all context moving procedures in XnAP, as it is supported in NGAP.

For example, in case RAN paging area covers multiple gNBs, the anchor gNB may formulate RAN paging message(s) that includes the Paging eDRX Information and transmit the RAN paging message(s) to other non-anchor gNB(s) via XnAP interface. After receiving the paging message(s) that includes the Paging eDRX information, each of the non-anchor gNB(s) can use the Paging eDRX Information to transmit paging message(s) to UEs in RRC inactive state.

Table 9 provided below shows a list of information elements that may be included in the RAN paging message(s) (as specified in TS 38.423).

TABLE 9

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.2.3.1 | | YES | reject |
| CHOICE UE Identity Index | M | | | YES | reject |
| Value | | | | | |
| >Length-10 | | | | | |
| >>Index Length-10 | M | BIT STRING | Coded as | — | |
| | | (SIZE(10)) | specified in TS | | |
| | | | 38.304 [33] and | | |
| | | | TS 36.304 [34]. | | |
| UE RAN Paging Identity | M | 9.2.3.43 | | YES | ignore |
| Paging DRX | M | 9.2.3.66 | | YES | ignore |
| RAN Paging Area | M | 9.2.3.38 | | YES | reject |
| Paging Priority | O | 9.2.3.44 | | YES | ignore |
| Assistance Data for RAN | O | 9.2.3.41 | | YES | ignore |
| Paging | | | | | |
| UE Radio Capability for | O | 9.2.3.91 | | YES | ignore |
| Paging | | | | | |
| Paging eDRX Information | O | 9.2.3.xx | Only present if | | |
| for NR | | | NG-RAN node | | |
| | | | is gNB | | |
| Paging eDRX Information | O | 9.2.3.yy | Only present if | | |
| for RedCap | | | NG-RAN node | | |
| | | | is gNB | | |

Shared eDRX Signaling

Even though, in the embodiments described above, the “eDRX parameters for NR” and the “eDRX parameters for RedCap” are separately signaled, in case the “eDRX parameters for NR” and the “eDRX parameters for RedCap” are the same, only one of the “eDRX parameters for NR” and the “eDRX parameters for RedCap” may be signaled.

Similarly, even though, in the embodiments described above, the “eDRX information for NR” and the “eDRX information for RedCap” are separately signaled, in case the “eDRX information for NR” and the “eDRX information for RedCap” are the same, only one of the “eDRX information for NR” and the “eDRX information for RedCap” may be signaled.

Furthermore, in case the eDRX information/parameters for NR, the eDRX information/parameters for Red Cap NR, and the eDRX information/parameters for WB-E-UTRA are the same, then the existing eDRX information/parameters (in Non-Access Stratum (NAS) and NGAP) may be used to represent the eDRX information/parameters for all three network accessing technologies.

All of the functions and/or steps described above may be virtualized in a cloud implementation.

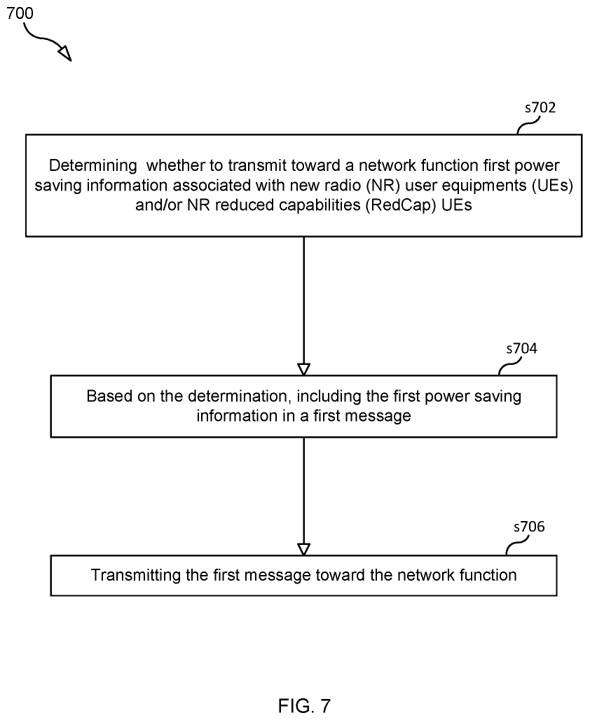

FIG. 7 shows a process 700 performed by the UE 102 according to one embodiment. The process 700 may begin with step s702. Step s702 comprises determining whether to transmit toward a network function first power saving information associated with new radio (NR) user equipments (UEs) and/or NR reduced capabilities (RedCap) UEs. Step s704 comprises, based on the determination, including the first power saving information in a first message. Step s706 comprises transmitting the first message toward the network function.

In some embodiments, the process further comprises receiving a second message from the network function and the second message comprises second power saving information associated with NR UEs and/or NR RedCap UEs.

In some embodiments, the first power saving information comprises Requested extended discontinuous reception (eDRX) parameters for NR and/or Requested eDRX parameters for RedCap, and the second power saving information comprises Negotiated eDRX parameters for NR and/or Negotiated eDRX parameters for RedCap.

In some embodiments, (i) the Requested eDRX parameters for NR and the Negotiated eDRX parameters for NR are different and/or (ii) the Requested eDRX parameters for RedCap and the Negotiated eDRX parameters for RedCap are different. The process further comprises the UE attempting to receive a paging message triggered by the network function using the Negotiated eDRX parameters for NR and/or the Negotiated eDRX parameters for RedCap.

In some embodiments, (i) the Requested eDRX parameters for NR and the Requested eDRX parameters for RedCap are the same and/or (ii) the Negotiated eDRX parameters for NR and the Negotiated eDRX parameters for RedCap are the same. The process further comprises the UE attempting to receive a paging message triggered by the network function using any of the Negotiated eDRX parameters for NR and the Negotiated eDRX parameters for RedCap.

In some embodiments, the first message is a Registration Request message for requesting the network function to register the UE, and the second message is a Registration Accept message indicating that the network function has registered the UE.

In some embodiments, the method further comprises determining a need to reduce power consumption of the UE, wherein whether to transmit toward the network function the first power saving information comprising Requested (eDRX) parameters for NR and/or Requested eDRX parameters for RedCap is determined based on the determination of the need to reduce the power consumption of the UE.

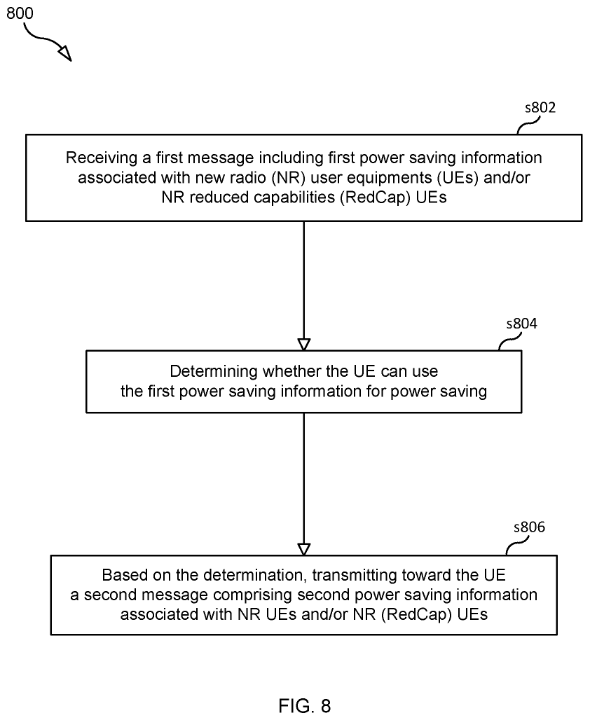

FIG. 8 shows a process 800 performed by a network function according to one embodiment. The process 800 may begin with step s802. Step s802 comprises receiving a first message including first power saving information associated with new radio (NR) user equipments (UEs) and/or NR reduced capabilities (RedCap) UEs. The first message was transmitted by a user equipment (UE). Step s804 comprises determining whether the UE can use the first power saving information for power saving. Step s806 comprises based on the determination, transmitting toward the UE a second message comprising second power saving information associated with NR UEs and/or NR (RedCap) UEs.

In some embodiments, the first power saving information comprises Requested extended discontinuous reception (eDRX) parameters for NR and/or Requested eDRX parameters for RedCap, and the second power saving information comprises Negotiated eDRX parameters for NR and/or Negotiated eDRX parameters for RedCap.

In some embodiments, determining whether the UE can use the first power saving information for power saving comprises determining that the UE cannot use the first power saving information for power saving, and

In some embodiments, (i) the Requested eDRX parameters for NR and the Negotiated eDRX parameters for NR are different and/or (ii) the Requested eDRX parameters for RedCap and the Negotiated eDRX parameters for RedCap are different.

In some embodiments, the first message is a Registration Request message for requesting the network function to register the UE, and the second message is a Registration Accept message indicating that the network function has registered the UE.

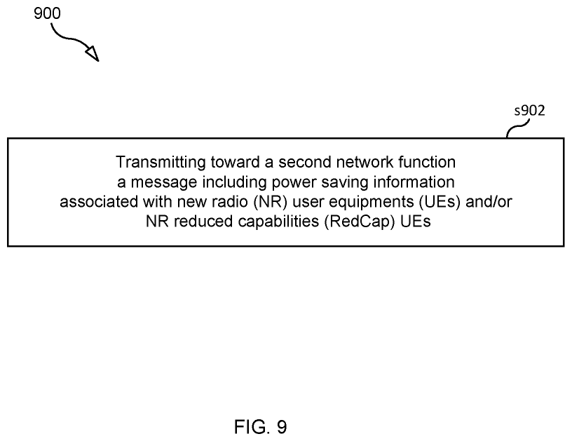

FIG. 9 shows a process 900 performed by a first network function according to one embodiment. The process 900 may being with step s902. Step s902 comprises transmitting toward a second network function a message including power saving information associated with new radio (NR) user equipments (UEs) and/or NR reduced capabilities (RedCap) UEs. The power saving information is used for transmitting a paging message towards a user equipment (UE) from the second network function.

In some embodiments, the message is any one of an Initial Context Setup Request message, a Handover Request message, a Path Switch Request Acknowledge message, and a UE Context Modification message, and the power saving information is Core Network (CN) Assistance Information for Radio Resource Control (RRC) inactive state information.

In some embodiments, the Core Network Assistance Information for RRC inactive state information comprises paging eDRX information for NR and/or paging eDRX information for RedCap. Each of the paging eDRX information for NR and the paging eDRX information for RedCap comprises: (i) paging eDRX cycle for idle, wherein the paging eDRX cycle for idle indicates a cycle of eDRX operation to be performed by the UE in idle state; (ii) paging eDRX cycle for inactive, wherein the paging eDRX cycle for inactive indicates a cycle of eDRX operation to be performed by the UE in inactive state; and/or (iii) paging time window, wherein the paging time window indicates the length of a paging time window (PTW) during which the second network function is configured to transmit the paging message toward the UE.

In some embodiments, the first network function is AMF, the second network function is a gNB, the message transmitted toward the gNB is a NGAP paging message formulated by the AMF, and the power saving information is for UEs in CM-IDLE state.

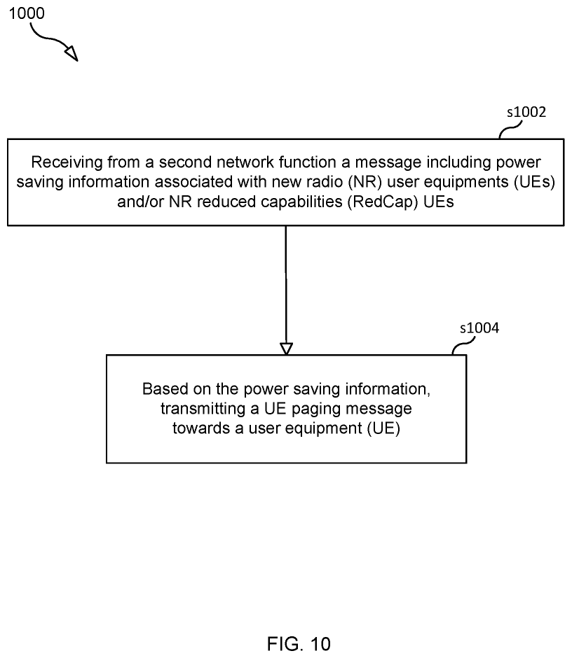

FIG. 10 shows a process 1000 performed by a first network function according to one embodiment. The process 1000 may begin with step s1002. Step s1002 comprises receiving from a second network function a message including power saving information associated with new radio (NR) user equipments (UEs) and/or NR reduced capabilities (RedCap) UEs. Step s1004 comprises based on the power saving information, transmitting a UE paging message towards a user equipment (UE).

In some embodiments, the first network function is a gNB, and the second network function is access and mobility and management function (AMF). The AMF transmitted the message to the gNB using new generation application protocol (NGAP), and the UE receiving the UE paging message is in connection management (CM) connected state with radio resource control (RRC) inactive state or CM idle state.

In some embodiments, the message is any one of an Initial Context Setup Request message, a Handover Request message, a Path Switch Request Acknowledge message, and a UE Context Modification message, and the power saving information is Core Network Assistance Information for Radio Resource Control (RRC) inactive state information.

In some embodiment, the Core Network Assistance Information for RRC inactive state information comprises paging eDRX information for NR and/or paging eDRX information for RedCap. Each of the paging eDRX information for NR and the paging eDRX information for RedCap comprises: (i) paging eDRX cycle for idle, wherein the paging eDRX cycle for idle indicates a cycle of eDRX operation to be performed by the UE in idle state; (ii) paging eDRX cycle for inactive, wherein the paging eDRX cycle for inactive indicates a cycle of eDRX operation to be performed by the UE in inactive state; and/or (iii) paging time window, wherein the paging time window indicates the length of a paging time window (PTW) during which the second network function is configured to transmit the UE paging message toward the UE.

In some embodiments, the first network function is a gNB distributed unit (DU), the second network function is a gNB central unit (CU) and the received message is a gNB paging message. Triggered by downlink signaling and data, the gNB CU transmitted the gNB paging message toward the gNB DU via F1 interface, and the UE receiving the UE paging message is in connection management (CM) connected state with radio resource control (RRC) inactive state.

In some embodiments, the first network function is a non-anchor gNB, the second network function is an anchor gNB, the received message is a gNB paging message, and triggered by downlink signaling and data, the anchor gNB transmitted the gNB paging message toward the non-anchor gNB via Xn interface, and the UE receiving the UE paging message is in connection management (CM) connected state with radio resource control (RRC) inactive state.

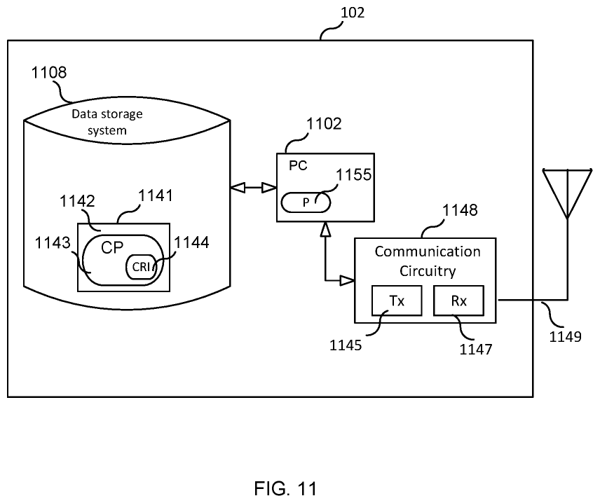

FIG. 11 is a block diagram of UE 102, according to some embodiments. As shown in FIG. 11, UE 102 may comprise: processing circuitry (PC) 1102, which may include one or more processors (P) 1155 (e.g., one or more general purpose microprocessors and/or one or more other processors, such as an application specific integrated circuit (ASIC), field-programmable gate arrays (FPGAs), and the like); communication circuitry 1148, which is coupled to an antenna arrangement 1149 comprising one or more antennas and which comprises a transmitter (Tx) 1145 and a receiver (Rx) 1147 for enabling UE 102 to transmit data and receive data (e.g., wirelessly transmit/receive data); and a local storage unit (a.k.a., “data storage system”) 1108, which may include one or more non-volatile storage devices and/or one or more volatile storage devices. In embodiments where PC 1102 includes a programmable processor, a computer program product (CPP) 1141 may be provided. CPP 1141 includes a computer readable medium (CRM) 1142 storing a computer program (CP) 1143 comprising computer readable instructions (CRI) 1144. CRM 1142 may be a non-transitory computer readable medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes UE 102 to perform steps described herein (e.g., steps described herein with reference to the flow charts). In other embodiments, UE 102 may be configured to perform steps described herein without the need for code. That is, for example, PC 1102 may consist merely of one or more ASICs. Hence, the features of the embodiments described herein may be implemented in hardware and/or software

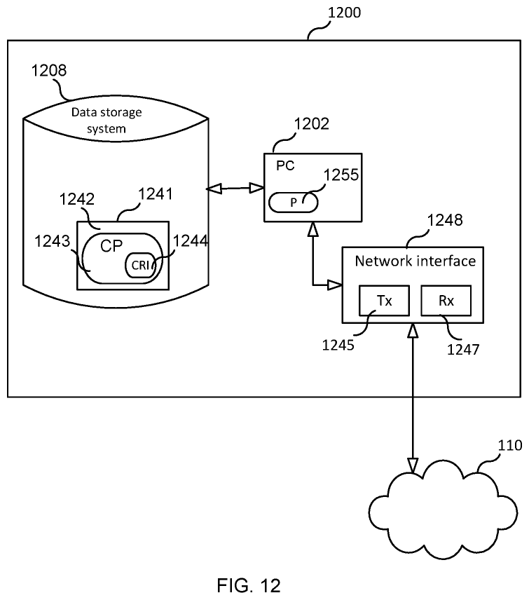

FIG. 12 is a block diagram of network function 1200 implementing at least a part of BS 104 or AMF 302, according to some embodiments. As shown in FIG. 12, network function 1200 may comprise: processing circuitry (PC) 1202, which may include one or more processors (P) 1255 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network function 1200 may be a distributed computing apparatus); at least one network interface 1248 (e.g., a physical interface or air interface) comprising a transmitter (Tx) 1245 and a receiver (Rx) 1247 for enabling network function 1200 to transmit data to and receive data from other nodes connected to a network 110 (e.g., an Internet Protocol (IP) network) to which network interface 1248 is connected (physically or wirelessly) (e.g., network interface 1248 may be coupled to an antenna arrangement comprising one or more antennas for enabling network function 1200 to wirelessly transmit/receive data); and a local storage unit (a.k.a., “data storage system”) 1208, which may include one or more non-volatile storage devices and/or one or more volatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes network function 1200 to perform steps described herein (e.g., steps described herein with reference to the flow charts). In other embodiments, network function 1200 may be configured to perform steps described herein without the need for code. That is, for example, PC 1202 may consist merely of one or more ASICs. Hence, the features of the embodiments described herein may be implemented in hardware and/or software.

In case the network function 1200 is the BS 104, the network function 1200 may additionally include an antenna and a communication circuitry that includes a transmitter, a receiver, and/or a transceiver. Using the antenna and the communication circuitry, the BS 104 is capable of performing a wireless communication with other network functions or UEs.

### Summary of Various Embodiments

A1. A method (700) performed by a user equipment (UE) (102), the method comprising:
determining (s702) whether to transmit toward a network function first power saving information associated with new radio (NR) user equipments (UEs) and/or NR reduced capabilities (RedCap) UEs;
based on the determination, including (s704) the first power saving information in a first message; and
transmitting (s706) the first message toward the network function.
A2. The method of embodiment A1, wherein
the method further comprises receiving a second message from the network function,
the second message comprises second power saving information associated with NR UEs and/or NR RedCap UEs.
A3. The method of embodiment A2, wherein
the first power saving information comprises Requested extended discontinuous reception (eDRX) parameters for NR and/or Requested eDRX parameters for RedCap, and
the second power saving information comprises Negotiated eDRX parameters for NR and/or Negotiated eDRX parameters for RedCap.
A4. The method of embodiment A3, wherein
(i) the Requested eDRX parameters for NR and the Negotiated eDRX parameters for NR are different and/or (ii) the Requested eDRX parameters for RedCap and the Negotiated eDRX parameters for RedCap are different,
the method further comprises the UE attempting to receive a paging message triggered by the network function using the Negotiated eDRX parameters for NR and/or the Negotiated eDRX parameters for RedCap.
A4b. The method of embodiment A3, wherein
(i) the Requested eDRX parameters for NR and the Requested eDRX parameters for RedCap are the same and/or (ii) the Negotiated eDRX parameters for NR and the Negotiated eDRX parameters for RedCap are the same, and
the method further comprises the UE attempting to receive a paging message triggered by the network function using any of the Negotiated eDRX parameters for NR and the Negotiated eDRX parameters for RedCap.
A5. The method of embodiment A2, wherein
the first message is a Registration Request message for requesting the network function to register the UE, and
the second message is a Registration Accept message indicating that the network function has registered the UE.
A6. The method of embodiment A2, the method further comprising determining a need to reduce power consumption of the UE, wherein whether to transmit toward the network function the first power saving information comprising Requested (eDRX) parameters for NR and/or Requested eDRX parameters for RedCap is determined based on the determination of the need to reduce the power consumption of the UE.
B1. A method (800) performed by a network function (302), the method comprising:
receiving (s802) a first message including first power saving information associated with new radio (NR) user equipments (UEs) and/or NR reduced capabilities (RedCap) UEs, wherein the first message was transmitted by a user equipment (UE) (102);
determining (s804) whether the UE can use the first power saving information for power saving; and
based on the determination, transmitting (s806) toward the UE a second message comprising second power saving information associated with NR UEs and/or NR (RedCap) UEs.
B2. The method of embodiment B1, wherein
the first power saving information comprises Requested extended discontinuous reception (eDRX) parameters for NR and/or Requested eDRX parameters for RedCap, and
the second power saving information comprises Negotiated eDRX parameters for NR and/or Negotiated eDRX parameters for RedCap.
B3. The method of embodiment B2, wherein
determining whether the UE can use the first power saving information for power saving comprises determining that the UE cannot use the first power saving information for power saving, and
(i) the Requested eDRX parameters for NR and the Negotiated eDRX parameters for NR are different and/or (ii) the Requested eDRX parameters for RedCap and the Negotiated eDRX parameters for RedCap are different.
B4. The method of embodiment B2, wherein
the first message is a Registration Request message for requesting the network function to register the UE, and
the second message is a Registration Accept message indicating that the network function has registered the UE.
C1. A method (900) performed by a first network function (302), the method comprising:
transmitting (s902) toward a second network function a message including power saving information associated with new radio (NR) user equipments (UEs) and/or NR reduced capabilities (RedCap) UEs, wherein the power saving information is used for transmitting a paging message towards a user equipment (UE) from the second network function.
C2. The method of embodiment C1, wherein
the message is any one of an Initial Context Setup Request message, a Handover Request message, a Path Switch Request Acknowledge message, and a UE Context Modification message, and
the power saving information is Core Network (CN) Assistance Information for Radio Resource Control (RRC) inactive state information.
C3. The method of embodiment C2, wherein
the Core Network Assistance Information for RRC inactive state information comprises paging eDRX information for NR and/or paging eDRX information for RedCap, and
each of the paging eDRX information for NR and the paging eDRX information for RedCap comprises:
   (i) paging eDRX cycle for idle, wherein the paging eDRX cycle for idle indicates a cycle of eDRX operation to be performed by the UE in idle state;
   (ii) paging eDRX cycle for inactive, wherein the paging eDRX cycle for inactive indicates a cycle of eDRX operation to be performed by the UE in inactive state; and/or
   (iii) paging time window, wherein the paging time window indicates the length of a paging time window (PTW) during which the second network function is configured to transmit the paging message toward the UE.
C4. The method of embodiment C1, wherein
the first network function is AMF,
the second network function is a gNB,
the message transmitted toward the gNB is a NGAP paging message formulated by the AMF, and
the power saving information is for UEs in CM-IDLE state.
D1. A method (1000) performed by a first network function (104), the method comprising:
receiving (s1002) from a second network function a message including power saving information associated with new radio (NR) user equipments (UEs) and/or NR reduced capabilities (RedCap) UEs, and
based on the power saving information, transmitting (s1004) a UE paging message towards a user equipment (UE).
D2. The method of embodiment D1, wherein
the first network function is a gNB, and
the second network function is access and mobility and management function (AMF).
the AMF transmitted the message to the gNB using new generation application protocol (NGAP), and.
the UE receiving the UE paging message is in connection management (CM) connected state with radio resource control (RRC) inactive state or CM idle state.
D3. The method of embodiment D2, wherein
the message is any one of an Initial Context Setup Request message, a Handover Request message, a Path Switch Request Acknowledge message, and a UE Context Modification message, and
the power saving information is Core Network Assistance Information for Radio Resource Control (RRC) inactive state information.
D4. The method of embodiment D3, wherein
the Core Network Assistance Information for RRC inactive state information comprises paging eDRX information for NR and/or paging eDRX information for RedCap, and
each of the paging eDRX information for NR and the paging eDRX information for RedCap comprises:
   (i) paging eDRX cycle for idle, wherein the paging eDRX cycle for idle indicates a cycle of eDRX operation to be performed by the UE in idle state;
   (ii) paging eDRX cycle for inactive, wherein the paging eDRX cycle for inactive indicates a cycle of eDRX operation to be performed by the UE in inactive state; and/or
   (iii) paging time window, wherein the paging time window indicates the length of a paging time window (PTW) during which the second network function is configured to transmit the UE paging message toward the UE.
D5. The method of embodiment D1, wherein
the first network function is a gNB distributed unit (DU),
the second network function is a gNB central unit (CU),
the received message is a gNB paging message,
triggered by downlink signaling and data, the gNB CU transmitted the gNB paging message toward the gNB DU via F1 interface, and
the UE receiving the UE paging message is in connection management (CM) connected state with radio resource control (RRC) inactive state.
D6. The method of embodiment D1, wherein
the first network function is a non-anchor gNB,
the second network function is a anchor gNB,
the received message is a gNB paging message, and
triggered by downlink signaling and data, the anchor gNB transmitted the gNB paging message toward the non-anchor gNB via Xn interface, and
the UE receiving the UE paging message is in connection management (CM) connected state with radio resource control (RRC) inactive state.
E1. A computer program (1143) comprising instructions (1144) which when executed by processing circuitry (1102) of a UE (102), causes the UE to perform the method of any one of embodiments A1-A6.
E2. A carrier containing the computer program of embodiment E1, wherein the carrier is one of an electronic signal, an optical signal, a radio signal, and a computer readable storage medium.
F1. A computer program (1243) comprising instructions (1244) which when executed by processing circuitry (1202) of a network function (104 or 302), causes the network function to perform the method of any one of embodiments B1-D6.
F2. A carrier containing the computer program of embodiment F1, wherein the carrier is one of an electronic signal, an optical signal, a radio signal, and a computer readable storage medium.
G1. A UE (102), the UE comprising:
processing circuitry (1102); and
a memory (1142), the memory containing instructions (1144) executable by the processing circuitry, whereby the UE is configured to perform any one of the embodiments A1-A6.
H1. A network function (104 or 302), the network function comprising:
processing circuitry (1202); and
a memory (1242), the memory containing instructions (1244) executable by the processing circuitry, whereby the network function is configured to perform any one of the embodiments B1-D6.
I1. A UE (102), the UE being configured to:
determine (s702) whether to transmit toward a network function first power saving information associated with new radio (NR) user equipments (UEs) and/or NR reduced capabilities (RedCap) UEs;
based on the determination, include (s704) the first power saving information in a first message; and
transmit (s706) the first message toward the network function.
I2. The UE of embodiment 11, wherein the UE is further configured to perform the method of any one of embodiments A2-A5.
J1. A network function (302), the network function being configured to:
receive (s802) a first message including first power saving information associated with new radio (NR) user equipments (UEs) and/or NR reduced capabilities (RedCap) UEs, wherein the first message was transmitted by a user equipment (UE);
determine (s804) whether the UE can use the first power saving information for power saving; and
based on the determination, transmit (s806) toward the UE a second message comprising second power saving information associated with NR UEs and/or NR (RedCap) UEs.
J2. The network function of embodiment J1, wherein the network function is further configured to perform the method of any one of embodiments B2-B4.
K1. A first network function (302), the first network function being configured to:
transmit (s902) toward a second network function a message including power saving information associated with new radio (NR) user equipments (UEs) and/or NR reduced capabilities (RedCap) UEs, wherein the power saving information is used for transmitting a paging message towards a user equipment (UE) from the second network function.
K2. The first network function of embodiment K1, wherein the first network function is further configured to perform the method of any one of embodiments C2-C4.
L1. A first network function (104), the first network function being configured to:
receive (s1002) from a second network function a message including power saving information associated with new radio (NR) user equipments (UEs) and/or NR reduced capabilities (RedCap) UEs, and
based on the power saving information, transmit (s1004) a UE paging message towards a user equipment (UE).
L2. The first network function of embodiment L1, wherein the first network function is further configured to perform the method of any one of embodiments D2-D6.

While various embodiments are described herein (an in any appendix), it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a first network function, the method comprising:
transmitting toward a second network function a message including power saving information associated with new radio (NR) user equipments (UEs) and/or NR reduced capabilities (RedCap) UEs, wherein the power saving information is used for transmitting a paging message towards a user equipment (UE) from the second network function.

2. The method according to claim 1, wherein
the message is any one of an Initial Context Setup Request message, a Handover Request message, a Path Switch Request Acknowledge message, and a UE Context Modification message; and
the power saving information is Core Network (CN) Assistance Information for Radio Resource Control (RRC) inactive state information.

3. The method according to claim 2, wherein
the Core Network Assistance Information for RRC inactive state information comprises paging eDRX information for NR and/or paging eDRX information for RedCap, and
each of the paging eDRX information for NR and the paging eDRX information for RedCap comprises:
(i) paging eDRX cycle for idle, wherein the paging eDRX cycle for idle indicates a cycle of eDRX operation to be performed by the UE in idle state;
(ii) paging eDRX cycle for inactive, wherein the paging eDRX cycle for inactive indicates a cycle of eDRX operation to be performed by the UE in inactive state; and/or
(iii) paging time window, wherein the paging time window indicates the length of a paging time window (PTW) during which the second network function is configured to transmit the paging message toward the UE.

4. The method according to claim 1, wherein
the first network function is AMF,
the second network function is a gNB,
the message transmitted toward the gNB is a NGAP paging message formulated by the AMF, and
the power saving information is for UEs in CM-IDLE state.

5. A method performed by a second network function, the method comprising:
receiving from a first network function a message including power saving information associated with new radio (NR) user equipments (UEs) and/or NR reduced capabilities (RedCap) UEs; and
based on the power saving information, transmitting a UE paging message towards a user equipment (UE).

6. The method according to claim 5, wherein
the second network function is a gNB, and the first network function is a access and mobility and management function (AMF);
the AMF transmitted the message to the gNB using new generation application protocol (NGAP); and,
the UE receiving the UE paging message is in connection management (CM) connected state with radio resource control (RRC) inactive state or CM idle state.

7. The method according to claim 6, wherein
the message is any one of an Initial Context Setup Request message, a Handover Request message, a Path Switch Request Acknowledge message, and a UE Context Modification message; and
the power saving information is Core Network Assistance Information for Radio Resource Control (RRC) inactive state information.

8. The method according to claim 7, wherein
the Core Network Assistance Information for RRC inactive state information comprises paging eDRX information for NR and/or paging eDRX information for RedCap, and
each of the paging eDRX information for NR and the paging eDRX information for RedCap comprises:
(i) paging eDRX cycle for idle, wherein the paging eDRX cycle for idle indicates a cycle of eDRX operation to be performed by the UE in idle state;
(ii) paging eDRX cycle for inactive, wherein the paging eDRX cycle for inactive indicates a cycle of eDRX operation to be performed by the UE in inactive state; and/or
(iii) paging time window, wherein the paging time window indicates the length of a paging time window (PTW) during which the second network function is configured to transmit the UE paging message toward the UE.

9. The method according to claim 5, wherein
the second network function is a gNB distributed unit (DU),
the first network function is a gNB central unit (CU),
the received message is a gNB paging message,
triggered by downlink signaling and data, the gNB CU transmitted the gNB paging message toward the gNB DU via F1 interface, and
the UE receiving the UE paging message is in connection management (CM) connected state with radio resource control (RRC) inactive state.

10. The method according to claim 5, wherein
the second network function is a non-anchor gNB,
the first network function is a anchor gNB,
the received message is a gNB paging message, and
triggered by downlink signaling and data, the anchor gNB transmitted the gNB paging message toward the non-anchor gNB via Xn interface, and
the UE receiving the UE paging message is in connection management (CM) connected state with radio resource control (RRC) inactive state.

11. A method performed by a user equipment (UE), the method comprising:
determining whether to transmit toward a network function first power saving information associated with new radio (NR) user equipments (UEs) and/or NR reduced capabilities (RedCap) UEs;
based on the determination, including the first power saving information in a first message; and
transmitting the first message toward the network function.

12. The method according to claim 11, wherein
the method further comprises receiving a second message from the network function,
the second message comprises second power saving information associated with NR UEs and/or NR RedCap UEs.

13. The method according to claim 12, wherein
the first power saving information comprises Requested extended discontinuous reception (eDRX) parameters for NR and/or Requested eDRX parameters for RedCap, and
the second power saving information comprises Negotiated eDRX parameters for NR and/or Negotiated eDRX parameters for RedCap.

14. The method according to claim 13, wherein
(i) the Requested eDRX parameters for NR and the Negotiated eDRX parameters for NR are different and/or (ii) the Requested eDRX parameters for RedCap and the Negotiated eDRX parameters for RedCap are different,
the method further comprises the UE attempting to receive a paging message triggered by the network function using the Negotiated eDRX parameters for NR and/or the Negotiated eDRX parameters for RedCap.

15. The method according to claim 13, wherein
(i) the Requested eDRX parameters for NR and the Requested eDRX parameters for RedCap are the same and/or (ii) the Negotiated eDRX parameters for NR and the Negotiated eDRX parameters for RedCap are the same, and
the method further comprises the UE attempting to receive a paging message triggered by the network function using any of the Negotiated eDRX parameters for NR and the Negotiated eDRX parameters for RedCap.

16. The method according to claim 12, wherein
the first message is a Registration Request message for requesting the network function to register the UE, and
the second message is a Registration Accept message indicating that the network function has registered the UE.

17. The method according to claim 12, the method further comprising determining a need to reduce power consumption of the UE, wherein whether to transmit toward the network function the first power saving information comprising Requested (eDRX) parameters for NR and/or Requested eDRX parameters for RedCap is determined based on the determination of the need to reduce the power consumption of the UE.

18. A method performed by a network function, the method comprising:
receiving a first message including first power saving information associated with new radio (NR) user equipments (UEs) and/or NR reduced capabilities (RedCap) UEs, wherein the first message was transmitted by a user equipment (UE);
determining whether the UE can use the first power saving information for power saving; and
based on the determination, transmitting toward the UE a second message comprising second power saving information associated with NR UEs and/or NR (RedCap) UEs.

19. The method according to claim 18, wherein
the first power saving information comprises Requested extended discontinuous reception (eDRX) parameters for NR and/or Requested eDRX parameters for RedCap, and
the second power saving information comprises Negotiated eDRX parameters for NR and/or Negotiated eDRX parameters for RedCap.

20. The method according to claim 19, wherein
determining whether the UE can use the first power saving information for power saving comprises determining that the UE cannot use the first power saving information for power saving, and
(i) the Requested eDRX parameters for NR and the Negotiated eDRX parameters for NR are different and/or (ii) the Requested eDRX parameters for RedCap and the Negotiated eDRX parameters for RedCap are different.

21. The method according to claim 19, wherein
the first message is a Registration Request message for requesting the network function to register the UE, and
the second message is a Registration Accept message indicating that the network function has registered the UE.

22-27. (canceled)

28. A UE comprising:
processing circuitry; and
a memory, the memory containing instructions executable by the processing circuitry, whereby the UE is configured to:
determine whether to transmit toward a network function first power saving information associated with new radio (NR) user equipments (UEs) and/or NR reduced capabilities (RedCap) UEs;
based on the determination, include the first power saving information in a first message; and
transmit the first message toward the network function.

29-35. (canceled)

36. A network function comprising:
processing circuitry; and
a memory, the memory containing instructions executable by the processing circuitry, whereby the network function is configured to perform:
(1) receiving a first message including first power saving information associated with new radio (NR) user equipments (UEs) and/or NR reduced capabilities (RedCap) UEs, wherein the first message was transmitted by a user equipment (UE), determining whether the UE can use the first power saving information for power saving, and based on the determination, transmitting toward the UE a second message comprising second power saving information associated with NR UEs and/or NR (RedCap) UEs;
(2) transmitting toward another network function a message including power saving information associated with new radio (NR) UEs and/or RedCap UEs, wherein the power saving information is used for transmitting a paging message towards a UE from said another network function; or
(3) receiving from another function a message including power saving information associated with new radio (NR) UEs and/or RedCap UEs, and based on the power saving information, transmitting a UE paging message towards a UE.
